(19) United States
(12) Patent Application Publication
(10) Pub. No.: US 2007/0272365 A1
(43) Pub. Date: Nov. 29, 2007

(54) Dual layer insect screen assembly

(76) Inventors: Michael Wingert, Urbandale, IA (US); Terry Kenkel, Urbandale, IA (US); Shawn Miller, Ankeny, IA (US); Korey Gearhart, Norwalk, IA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/437,360

(22) Filed: May 19, 2006

(51) Int. Cl. A47H 1/00; E06B 3/32

(52) U.S. Cl. 160/98

(57) ABSTRACT

A dual layer insect screen assembly for fenestration units has a first screening layer for blocking passage of insects through the fenestration unit. A second screening layer is moveable over the first screening layer to provide additional shading, light reflection, and other variable optical effects, while still allowing ventilation through the fenestration unit.

### FIELD OF THE INVENTION

The present invention generally relates to fenestration units having insect screens, and in particular, to a fenestration unit including multiple screening structures for blocking passage of insects and providing variable optical effects such as shading, light diffusion, etc., while still permitting ventilation therethrough.

### BACKGROUND OF THE INVENTION

Fenestration units having layers of screening material covering at least a portion thereof to exclude or block the passage of insets through the fenestration unit are well known. Such fenestration units include screen doors, window screens, and other similar assemblies. The screening materials used for covering fenestration units, commonly referred to as insect screens, typically include woven meshes of metal wire or glass fibers having openings small enough to prevent the passage of insects therethrough, while also permitting ventilation through the screen. “Insect Screen” also is a term of art and refers to screening that meets a variety of ASTM and industry standards making the screening commercially viable and acceptable for use as insect screen. The wire or glass fiber mesh materials of insect screens further preferably are coated with a polymeric material to help bond the wire or glass fibers or filaments at their intersection points, to help improve durability and provide additional dimensional stability for the screen, as well as to protect the screening elements from corrosion and wear, and in some instances, to impart particular color to the screening material. Such polymeric coatings may be applied to the woven mesh after its formation, or can be applied to the individual components or elements prior to weaving them together. The mesh components further are treated with a fusing or curing process to seal the polymeric coating.

In addition, such insect screens or fenestration units can be formed as retractable insect screens attached to the fenestration units. For example, patio doors can have retractable screens that are retracted into a cassette located at the edge of the door frame when not in use, to allow use of the door for entering and exiting, and thereafter pulled out over the door area when it is desirable to have the door open for ventilation, but where insects or other pests are to be excluded.

### SUMMARY OF THE INVENTION

Briefly described, the present invention relates to a dual layer insect screen assembly for fenestration units, which is adapted to deter or prevent the passage of insects and potentially large sized airborne particles or particulate matter from passing through the fenestration unit, as well as to provide variable optical effects such as shading, reflection, and light diffusion, while still permitting the passage of ventilating air through the fenestration unit. The fenestration unit typically can comprise a door, window, or other similar structure, having a peripheral frame defining an open area therein. A first screening layer generally will be mounted to the frame of the fenestration unit, covering the open portion thereof. A second screening layer generally will be positioned adjacent and can be superimposed over the first screening layer. At least one of the first and/or second screening layers can be attached to a retracting mechanism so as to be moveable between a first, fully retracted position, a second fully extended position, and a series of intermediate positions between the retracted and extended positions, thereby providing a choice of screen performance characteristics to the fenestration unit.

The first and second screening layers typically will be formed from screening materials comprising wire, synthetic or glass fiber mesh. The screening material of the first screening layer can have an open area percentage of approximately 50%-70%, although greater or lesser open area percentages can be provided as desired, to provide a basic level of screening and light transmittance for everyday use. The screening material of the second screening layer can comprise a screen material having a lower percentage of open area and thus a light transmittance less than that of the first screen layer to provide a further reduction in light transmittance through the fenestration unit without significantly hampering or blocking the flow of ventilation therethrough. The second screening layer can be moved along or over the first screening layer to a desired intermediate position to provide the fenestration unit with further varying or adjustable optical effects such as increased shading, reflection, and/or light diffusion, while the first screening layer tends to block the passage of insects or larger airborne particulate matter, while still allowing the desired ventilation through the fenestration unit.

Various features, objects, and advantages of the present invention will become apparent to those skilled in the art upon review of the detailed description below, when taken in conjunction with the accompanying drawings, which are briefly described as follows.

### BRIEF DESCRIPTION OF THE DRAWINGS

FIG. 1 is a side elevational view of a fenestration unit incorporating-the dual insect screen of the present invention.

FIG. 2 is an end view taken in partial cross section of a portion of the fenestration illustrating the first and second screen layers mounted thereto.

FIG. 3 is an end view of a retraction assembly for use with the second screen layer.

FIG. 4 is a side view of a spline for use in the retracting mechanism of FIG. 3.

FIG. 5 is a side view illustrating the engagement of the latches of the second screening layer.

### DETAILED DESCRIPTION OF THE INVENTION

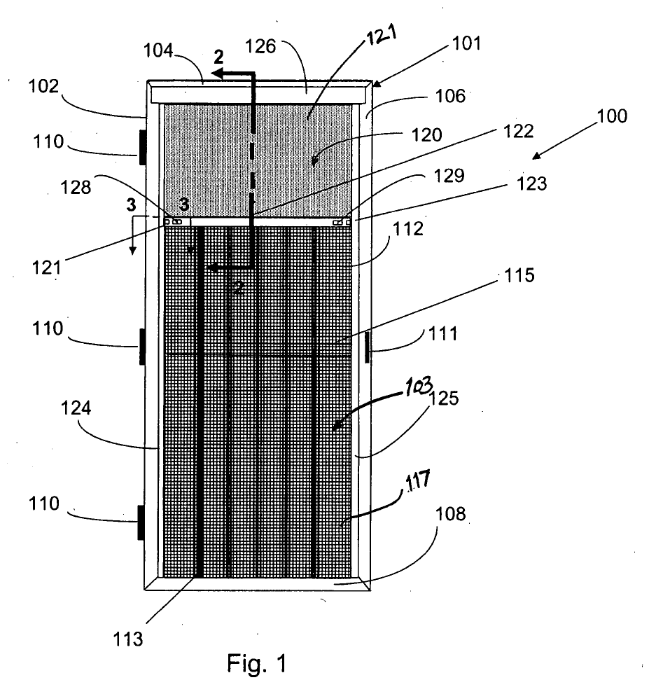

Referring now to the drawings in which like numerals indicate like parts throughout the several views, FIG. 1 generally illustrates a fenestration unit, here shown as a screen door panel 100, incorporating the dual screen assembly of the present invention. It will be understood that while a screen door panel is illustrated herein as an example embodiment of the use of the dual screen assembly and insect screen assembly of the present invention, other structures or fenestration units such as windows, other types of doors, etc., also can be used. As shown in FIG. 1, the screen door panel 100 generally includes a peripheral frame structure 101 to which first and second screening layers or assemblies 112 and 120, respectively, are mounted. The peripheral frame structure 101 of the screen door panel 100 can include a hinged stile 102, a top rail 104, lock stile 106, and a bottom rail 108, which typically are connected in an end-to-end manner to form a substantially rectangular structure defining the peripheral frame 101 as shown in FIG. 1. The peripheral frame accordingly defines an open portion or area 103 that can extend substantially along the length of the door panel, potentially including substantially the entire span of the door panel from the top rail 104 to the bottom rail 108.

The peripheral frame structure 101 typically is formed from a variety of materials having a sufficient mechanical strength and resistance to weathering so as to withstand exposure to wind, rain, and other elemental factors when used outdoors, and typically will be provided with an aesthetic appearance or design. The hinge stile 102, top rail 104, lock stile 106 and bottom rail 108 of the peripheral frame structure accordingly can be formed from various stock materials such as wood, various plastic or synthetic materials, or various metal or metal alloys. For example, the elements of the frame structure can be formed from aluminum extrusion having a cross sectional profile or area designed to fit within the confines of a door jam, with the extruded peripheral frame components typically having mitered ends to enable end to end fitting or mating of the pieces at the corners therebetween. Channels, sometimes called screw chases, also can be provided as part of the internal profile (not shown) of the extruded components for receiving screws or other fasteners for attaching or fastening the frame components together at their corners in a manner known in the art. The peripheral frame structure additionally can be painted or coated prior to or after being assembled, and a sealant or other protectant also can be applied. Alternatively, in the event that polymeric materials rather than extruded metal materials or wood are used, it also is possible to extrude a colorant with the extruded polymeric stock material, so as to eliminate the need for later painting or otherwise coloring the peripheral frame structure.

As generally illustrated in FIG. 1, the screen door panel 101, or other fenestration unit, typically is conventionally supported in a support frame such as a door frame (not shown) by hinges 110, which enable the pivoting or swinging motion of the door panel. The door panel further can be releasably locked or held in a closed position against the doorframe by a lock assembly 111. Vertically extending support bars 113 can be attached to the bottom and/or top rails 118 and 114, and/or a center cross bar 115 can be attached to the hinge and lock stiles 102 and 106 of the peripheral frame structure 101. The vertical bars 118 and cross bar 115 provide additional stability and security against intruders attempting to pass through the open area or portion defined by the frame of the door panel. The vertical bars and center cross bar can also help enhance the rigidity of the door panel to reduce the potential that the peripheral frame structure could be deformed by screen tension imparted by the first and second screening assemblies. In an alternative embodiment, the vertical bars and center cross bar 113 and 115, respectively, can be formed as part of an intermediate screen frame (not shown) to which the first and second screen assemblies 112 and 120 can be mounted. Such an intermediate screen frame further can be attached to the peripheral frame structure in such a manner that it can be removed as a replaceable unit from the peripheral frame structure and replaced by a window or other panel component as desired as known in the fenestration industry.

The first screening assembly 112 generally can be fixedly attached directly to the peripheral frame structure 101 of the door panel 100 by conventional attachment mechanisms, such as a spline and groove attachment system as known in the art. Alternatively, the first screening assembly can be attached to an intermediate screen frame (not shown) that, in turn, is releasably attached to the peripheral frame structure 101, such as through the use of clips, bolts, or other types of similar fasteners. As a result, the first screening assembly and intermediate frame can be removed as a replaceable unit from the peripheral frame structure 101 and replaced by a window panel or other similar component when needed or desired. The attachment of the first screening assembly 112 to the peripheral frame structure 101 further generally will be done in accordance with suitable attachment standards for the attachment of screen materials to a frame as set forth in Screen Manufacturer Association's Standard SMA SMT 31-1990-R998, which specifies the procedures and equipment for testing the attachment of screen materials to a frame.

Insect screening materials 117 suitable for use in the first screening assembly 112 generally can include a variety of mesh, lattice, or other conventional insect screening materials formed from metal wire, or synthetic, polymer, or glass fibers or filaments that are woven together with interstitial spacings therebetween to form the insect screening material. The insect screening material 117 used for the first screening assembly 112 generally will be chosen as having spacing sufficiently small to block the passage of most flying insects, including gnats, mosquitoes, etc., and potentially can be selected to retard the passage of some airborne particulates of a desired size, while still providing sufficient open area to permit the adequate ventilation and passage of light therethrough. Suitable insect screening materials can include vinyl coated glass yams, metal wire mesh materials, other similar materials capable of passing ASTM standard test procedure D-3656-97, or alternatively, Screen Manufacturers Association Standard SMA1201-1202, and exhibiting other properties understood by skilled artisans to be inherent in “insect screening.”

One example of a screening material 117 for use in the first screening assembly 112 can have a mesh density of approximately 15-20 elements per inch, and preferably approximately 18 elements per inch in the horizontal direction, and approximately 10-18 elements per inch, and preferably about 14 elements per inch in the vertical direction, with an average element diameter of approximately 0.010-0.015 inches. The open area of such screening material can be approximately 60%-62%, although screen materials with greater or lesser open areas, i.e., upwards of 50%-80% open area, or further lesser or greater amounts also can be used. An amount of open area of about 60%-62% typically results in a light transmittance for the screen material of approximately 60-62% for light incident the plane of the screen, such that about 38%-40% of the incident light is not transmitted. With a screen material having an increased open area, the amount of light transmittance therethrough accordingly will be increased, while as the open area of the first screen material is reduced, the light transmittance level therefore likewise will be reduced.

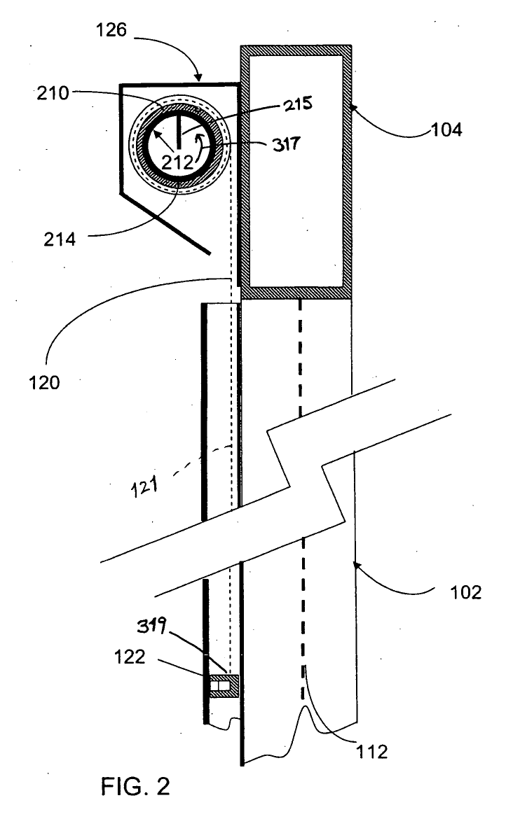

As shown in FIGS. 1 and 2, the screen door panel 100 further comprises a second screening layer or assembly 120. In the embodiment shown, the second screening assembly 120 is generally is illustrated as being mounted in and retractable into a cassette 126, which typically is attached to the top rail 104 of the peripheral frame structure 101. The cassette 126 generally is formed from a material similar to the peripheral frame structure components and can be flush mounted to an outer side surface of the top rail, or can be mounted within a recess formed in the top rail so as to reduce the profile thereof. Alternatively, the second screening assembly 120 can be mounted within or along the top rail 104 itself, without the need for a separate, externally mounted cassette 126. As indicated in FIGS. 1 and 2, the second screening assembly 120 is retractable into its cassette 126, and can be extended from a first, fully retracted position, whereupon it is withdrawn and substantially completely retracted into the housing of the cassette 126, to a second, fully extending position extending substantially along the length of the door panel and potentially to a position adjacent the lower or bottom rail 108 of the frame structure. The second screening assembly further can be adapted to be moved and set at a series of intermediate positions between its fully retracted and fully extended positions, so as to cover the first screening assembly 112 to a desired extent.

The screening materials 121 utilized for the second screening assembly 120 can be chosen from a variety of screening materials depending upon the specific effect to be achieved. In particular, to provide additional light shading for the screen door panel or other fenestration unit in which the dual insect screen assembly of the present invention is used, the screening material 121 utilized for the second screening assembly 120 typically will be selected as having an open area less than that of the screening material 117 of the first screening assembly 112 so that the light transmitted through the screen door panel can be further significantly reduced as needed or desired, while still allowing ventilation.

For example, the screening material 121 of the second screening assembly 120 can have a reduced open area of approximately 20%-60%, and typically less, to provide an enhanced shading effect. One example screening material that can be used is “Dura-Sun Coated Mesh” available from Duracoat Corporation, such as material stile no. 6366, which has approximately 20% open area to reduce light transmittance therethrough to approximately 20%. It also will be understood, however, that while screening materials having a lower percentage of open area generally have been found to provide an enhanced shading effect, variations in shading can be provided as desired, including utilizing a screening material 121 for the second screening assembly 120 having approximately the same percentage of open area as the screening material 117 of the first screening assembly 112 to provide a reduced level of shading and/or reflectance for the screen door panel as needed or desired.

In addition, as lighter colors have been found to be useful for reflecting greater amounts of sunlight, the screening material of the second screening assembly can be coated or otherwise colored in lighter, more reflective colors to enhance the reflectance of sunlight striking the screen door panel to help promote cooler temperatures in the area of the screen door, particularly in the space between the screen door and any entry door that may be present. It also has been found that lighter colored screening material of the second screening assembly further tends to help mask moiré interference patterns that can appear on the interior side of the second screening assembly as light passes through both layers of the screening materials from the exterior of the door panel.

In addition, it is preferable that the wire mesh, synthetic, polymer, or glass fibers or filaments of the screening material 121 utilized for the second screening assembly 120 be relatively thin and flexible, such that when retracted or rolled up into its cassette about roller 210, the outside diameter of the roll will be as small as possible so as to reduce the size or profile of the cassette 126. Further, since the screening material is rolled directly onto a smaller diameter roll, more flexible materials such as glass fiber or polymeric screening materials, rather than stiffer metal materials, are preferred.

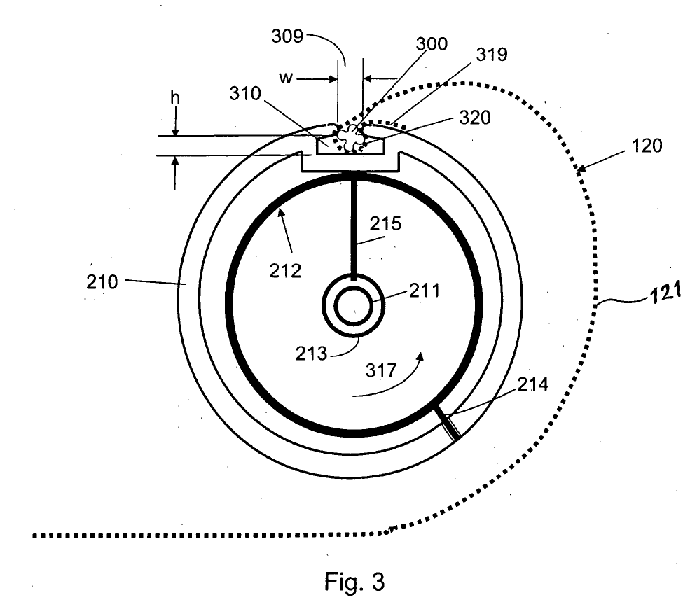

A variety of alternative mechanisms can be used for extending and retracting the second screening assembly and holding it in an intermediate position. For example, in FIGS. 2-3, a screening material of a second screening assembly 120 can be attached at a top or upper end thereof to a roller or retractor mechanism 210 that is rotatably mounted within cassette 126. The roller 210 generally will be attached to a torsion spring 212 that will urge or cause the roller 210 to rotate in the direction of arrow 317 (FIG. 3) to wind up the screening material of the second screening assembly 120 onto itself, consequently pulling the screening material upwardly toward and into the cassette 126. As shown in FIG. 3, the torsion spring 212 will be mounted about a center support bar 211 by a collar 213 attached to the spring 212 by an attachment strut or rib 215. The spring further will be attached to the roller 210 by a rib or fastener 214.

As shown in FIGS. 1 and 2, a pull bar 122 is mounted along a bottom edge 318 (FIG. 2) of the screening assembly 120 for enabling the user to pull down the screening material by application of a force sufficient to overcome the winding or tension force provided by the torsion spring 212, so as to bring down the screening material of the second screening assembly 120 to a position overlying the first screening assembly 112 to provide the dual layer screening effects of the present invention. Additional springs for providing tension, coupled to the roller 210 through a cable or other similar coupling, engaging or applied about a portion of the roller also can be used. Still further, it is possible to utilize other mechanisms such as motors, cylinders, or other actuators, possibly with an electronic remote control for controlling the extension and retraction of the second screening assembly 120.

Attachment of the screening material of the second screening assembly 120 to the roller 210 can be accomplished by any suitable means, provided that the attachment is sufficiently robust to withstand the forces necessary to pull the screen down to its fully extended position and provided that the attachment mechanism still enables the screening material to be wound smoothly about and onto the roller 210. As indicated in FIG. 3, the roller 210 typically is provided with a longitudinal gap 309 that opens into a longitudinal cavity 310. The screening material 121 of the second screening assembly 120 is attached to the roller 210 generally by first aligning it with its longitudinal edges perpendicular to the axis of rotation of the roller 210 and with its upper longitudinal edge or end portion 319 slightly overlapping the gap 309. It should be noted in FIG. 3 that the screening material is positioned relative to the roller 210 so as to cause the screening material to be wound up onto the roller 210 when the torsion spring 212 urges the roller 210 to rotate in a counterclockwise direction as indicated by arrow 317. With the screening material positioned or received within and overlapping the gap 309, a spline 300 thereafter can be inserted into the gap 309 while the alignment of the longitudinal edges of the screening material of the second screening assembly 120 is maintained substantially perpendicular to the axis of rotation of the roller 210. The screening material then is folded over the roller 210 so as to pass over the gap 309 in the manner as shown in FIG. 3.

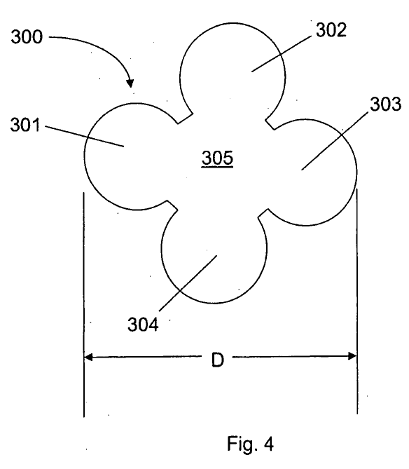

The spline 300 (FIG. 4) typically is formed from a elastomeric or suitably flexible polymeric material, although other durable, flexible materials also can be used, and generally be an elongated component having a substantially + or X shaped cross-section as indicated in FIG. 4. For example, the spline 300 can have a series of arms or lobes 301-304 extending radially outwardly from a center body portion 305 and can be extruded from a polymeric or elastomeric stock material, and cut to a suitable length. The spline generally will be configured and sized to produce, in cooperation with the cavity 310 (FIG. 3) and gap 309, a coupling with the roller 210 having enhanced strength, while still being easily installable through the gap 309 and into the cavity 310 with an insertion pressure sufficiently low to allow relatively easy assembly without significant risk of damaging the screen material or causing misaligning of the edges of the screening material relative to the roller. In addition, the width w of the gap 309, the height h of the cavity 310, and the cross-sectional width D (FIG. 4) of the spline 300 preferably are chosen to provide a sufficiently robust coupling of the screening material 121 (FIG. 3) of the second screening layer or assembly 120 to the roller 210 with a relatively minimal insertion pressure during assembly. Other configurations or shapes, such as rectangular lobes or a spline that has more or less than four lobes also can be used.

Alternative embodiments for the attachment of the screening material of the second screening assembly 120 to the roller 210 also are possible. For example, one or more coupling devices, such as clips, brackets, or other similar connectors can be fixedly attached to the end 319 of the screening material prior to its assembly about the roller 210. Such a coupling device or connector can be attached or coupled to the roller 210 by sliding it into the cavity 310 through one end thereof. Additionally, the end 319 of the screening material also can be attached through the use of adhesive materials, either alone or in combination with mechanical couplings.

Similarly, the pull bar 122 (FIG. 2) attached to the opposite end 318 of the screening material 121 of the screening assembly 120 can be mounted or attached to the screening material 121 with clips or other coupling devices, adhesive materials, or it can be wrapped and sewn into a pocket or otherwise encapsulated into the end of the screening material. The method of attachment of the pull bar to the screening material generally is not critical, provided that the attachment is sufficiently robust to withstand the forces applied to the screening material when the user pulls on the pull bar, while still enabling the pull bar to be sufficiently compact to fit into the available space. Conventional attachment mechanisms such as a spline and groove commonly used for screen attachment in the fenestration field or industry also can be used.

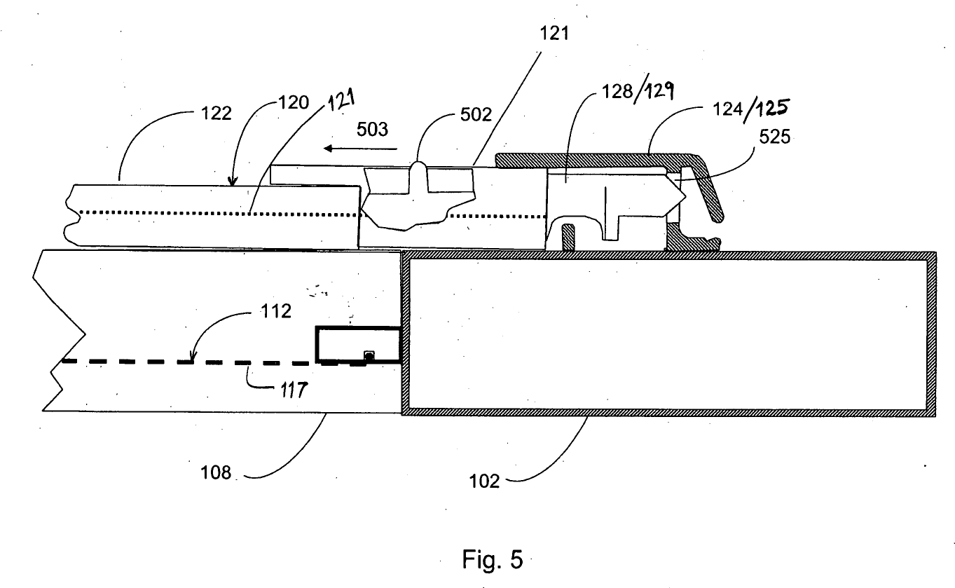

In a preferred embodiment as indicated in FIG. 1, the pull bar 122 further can be guided by vertical guide tracks 124 and 125, which hold the screening material 121 of the second screening assembly 120 in a predetermined plane relative to first screening assembly 112. The guide tracks 124 and 125 also can contain apertures or notches 525, as shown in FIG. 5, for receiving pull bar latches 128 and 129. Latches 128 and 129 are incorporated into pull bar 122 for locking the pull bar 122 in particular or desired positions or locations along the length of the screen door and first screening assembly 112, thereby setting the extent to which second screening assembly 120 overlays first screening 112. Latch release tabs 502 generally are attached along the-locking pull bar 122 for releasing engagement of the latches 128/129 as the tabs are moved in the direction of arrow 503 to enable retraction of the screening material 121 along the screen door panel. It further will be recognized that the mechanism for locking the pull bar 122 in predetermined positions along guide tracks 124 and 125 is not limited to the particular type of sliding latches disclosed hereinabove. Any suitably sized, easily hand operated latching mechanism can be used, as will be apparent to those skilled in the art. Moreover, the latching mechanism need not utilize latches received by apertures. Serrated structures or frictionally engaging locking devices also can be used. Additionally, mechanical linkages coupling the latching devices to a central activating device so as to allow pull bar 122 to be operated with one hand, may also be used.

It will be recognized that since the purpose of second screening assembly 120 (FIG. 1) is to reduce light transmission beyond the reduction provided by a single screen layer, weather stripping or other blocking or sealing components may or may not be needed along the longitudinal side edges of second screening assembly 120, since light generally travels in rectilinear paths. There may, however, be instances wherein sealing of the sides of the second and/or first screening assemblies with weather stripping or other sealing means may be useful, such as when very small insects are to be excluded. An advantage of leaving the edges unconstrained, however, is that in strong winds, the screening material of the second screening assembly 120 can billow out, unrolling as much of screening material 121 as needed to balance the wind force with the torque of roller 210 (FIG. 2), thereby allowing the wind to flow around the screening material 121, and reducing the risk of damage to second screening material 121, roller 210, or other components of the second screening assembly.

It further will be appreciated that while it is often preferable that the screen storage cassette be located at the top of the screened area of the screen door or other fenestration unit, it is contemplated that there may be instances wherein it is preferred to store the retracted screening material at another location, such as at the bottom of the screened area, or at a side of the screened area. In door panels wherein the screened area covers a relatively small portion of the panel, the second screening assembly may not be required to roll up, but could simply be held in a flat frame and carried by a sliding mechanism either partially or completely into a compartment in the unscreened, solid portion of the door.

It will be understood by those skilled in the art that while the present invention has been described above with reference to preferred embodiments, numerous variations, modifications, and additions can be made thereto without departing from the spirit and scope of the present invention as set forth in the following claims.

What is claimed is:

1. A fenestration panel comprising:
a frame defining an open portion;
a first screening layer covering the open portion;
a second screening layer on the frame and moveable between a first position at least partially overlying the first screening layer to form a dual layer screen with the first screening layer, and a second position substantially not overlying the first screening layer,
the second screening layer having a light transmittance less than a light transmittance of the first screening layer.

2. A fenestration panel according to claim 1, wherein the first and second screening layers have open areas and wherein the second screening layer has an open area less than the open area of the first screening layer.

3. A fenestration panel according to claim 1, wherein the second screening layer is moveable to an immediate position between the first position and the second position.

4. A fenestration panel according to claim 1, wherein the first and second screening layers have a lightness and the second screening layer is lighter than the first screening layer.

5. A fenestration panel according to claim 1 and wherein the first screening layer comprises a screening material having a light transmittance of up to about 70%.

6. A fenestration panel according to claim 5 and wherein the second screening layer comprises a screening material having a light transmittance of less than about 50%.

7. A fenestration panel according to claim 1 and wherein said second screening layer comprises a screening material having up to an about 50% open area.

8. A fenestration unit comprising:
a frame defining an opening;
a first screen mounted to said frame spanning said opening;
a second screen mounted to said frame;
said second screen being selectively moveable between a first position at least partially spanning said opening and at least partially overlying said first screen and a second position substantially displaced from and not overly said first screen.
